(19) United States
(12) Patent Application Publication
(10) Pub. No.: US 2008/0143104 A1
(43) Pub. Date: Jun. 19, 2008

(54) Subsea Piping System

(76) Inventor: Robert J. Logan, Houston, TX (US)

Correspondence Address: BUSKOP LAW GROUP, P.C., 4511 Dacoma Street, HOUSTON, TX, 77092, US

(21) Appl. No.: 11/612,376

(22) Filed: Dec. 18, 2006

(51) Int. Cl. F16L 21/08

(52) U.S. Cl. 285/237

(57) ABSTRACT

A first tubular member including a first tubular body having a first pin end and a first bell end opposite the first pin end, a second tubular member with a second tubular body having a second pin end and a second bell end opposite the second pin end, a third tubular member having a third tubular body having at least one third pin end, and a fourth tubular member comprising a fourth tubular body comprising at least one third bell end.

### FIELD

The present embodiments of the invention relate generally to a subsea piping system.

### BACKGROUND

In the pipeline industry there is a need for a subsea piping system having mechanical joints. This need also exists in other industries requiring the assembly of piping systems. This subsea piping system eliminates the need for work site welding.

In the deep water pipeline industry there exists a need for a subsea piping system having a fast setting epoxy compound within the joint coupling the tubular members together allowing the mechanically joined tubular members to be deployed into deep water in a relatively short period of time.

The piping system needs to withstand harsh environmental conditions for a significant length of time. This is particularly true with subsea piping systems.

There exists a need for a subsea piping system that is coated with a powder epoxy or a three layer polyethylene. Specifically, there exists a need for a subsea piping system where the individual tubular members are mechanically joined together.

The present embodiments meet these needs.

### BRIEF DESCRIPTION OF THE DRAWINGS

The detailed description will be better understood in conjunction with the accompanying drawings as follows:

FIG. 1 depicts an exploded view of the first tubular member and second tubular member joined together by an interference fit.

FIG. 2 depicts an alternative embodiment of the second pin end with an inverted bevel.

FIG. 3 depicts a cut assembled view of the first tubular member and second tubular member joined together.

FIG. 4 depicts a side elevation view of the assembled subsea piping system.

The present embodiments are detailed below with reference to the listed Figures.

### DETAILED DESCRIPTION OF THE EMBODIMENTS

Before explaining the present embodiments in detail, it is to be understood that the embodiments are not limited to the particular embodiments and that they can be practiced or carried out in various ways.

The embodiments of the invention generally relate to a subsea piping system. The subsea piping system can have a first tubular member.

The first tubular member can have a first tubular body. The first tubular body can have a first pin end and a first bell end opposite the first pin end.

The embodiments of the subsea piping system can have a second tubular member with a second tubular body. The second tubular body can have a second pin end and a second bell end opposite the second pin end.

The embodiments of the subsea piping system can have a third tubular member with a third tubular body comprising at least a third pin end.

The embodiments of the piping system can have a fourth tubular member with a fourth tubular body having at least a third bell end.

The first bell end has a first interior sized to form a first interference fit with the second pin end. The second tubular member has a second exterior, a second tapered portion formed between the second tubular body and the second pin end, and a second annular groove formed within the second tubular body.

The first tubular member can have a smooth fusion powder epoxy coating disposed on a first portion of the first tubular body to prevent corrosion; such as that made by 3M such as Scotchkote™ 6233.

In an alternative embodiment the smooth fusion epoxy coating call be a three layer polyethylene coating. The three layers would be the fusion bond material described above, a mastic and a polyethylene. The polyethylene can be high density polythene such as available from the Shell Chemical Company.

The first tubular member also can have the first bell end, and the second tubular member has the smooth fusion powder epoxy coating disposed on a second portion of the second tubular body, and the second bell end.

A fast setting epoxy compound, such as a liquid fast setting epoxy compound, such as a mixture of 85% epoxy resin and 15% inert ingredients for friction reduction, as a lubricant, and for pigmentation for use in assembling the tubulars, can be applied to the interior of the first bell end and the exterior of the second pin end. The fast setting epoxy compound fills the second annular groove and a second adjacent space between the second annular groove and the second tapered portion.

In an alternative embodiment, the fast setting epoxy compound can comprise a two part formulation which includes a base and an accelerator, such as product 135-8505, available from Bradley Coatings Group.

The base comprises approximately 60% epoxy resin, such as triglycidyl isocyanurate, by weight, approximately 2% dispersion agent, approximately 3% hydrocarbon resin, such as an aromatic hydrocarbon resin, approximately 4% titanium dioxide, approximately 15% micro-crystalline filler, approximately 15% talc, and approximately 1% flatting agent, such as silica gel.

The accelerator comprises approximately 4% epoxy reactive diluent, such as 1,4-butanediol diglycidyl ether, by weight, approximately 10% of a hybrid reactive polyamide, for example UNI-REZ 1289 produced by Arizona Chemical, approximately 35% epoxy curing agent, such as an alkenyl or alkyl substituted succinic anhydride, approximately 10% dimethylamino-accelerator, approximately 1% phthalo blue dispersion, approximately 20% talc, and approximately 20% micro-crystalline filler.

The third bell end can have an interior sized to form a second interference fit with the first pin end. The first tubular has a first pin end, a first exterior, a first tapered portion formed between the first tubular body and the first pin end, and a first annular groove formed within the first tubular body.

The fourth tubular member comprises the smooth fusion powder epoxy coating disposed on the fourth tubular body and the third bell end. The fast setting epoxy compound can be applied to the third interior of the third bell end and the first exterior of the first pin end, wherein the fast setting epoxy compound fills the first annular groove and a first adjacent space between the first annular groove and the first tapered portion.

The first end of the fourth tubular member opposite the third bell end can be a connection to a supply source, such as a subsea wellhead.

The second bell end of the second tubular member comprises a second interior sized to form a third interference fit with the third pin end.

The third pin end has a third exterior, a third tapered portion formed between the third tubular body and a third tubular body, and a third annular groove formed within the third tubular body of the third pin end.

The third tubular member can have the smooth fusion powder epoxy coating disposed on a third portion of the third tubular body.

The fast setting epoxy compound is applied to the second interior of the second bell end and the third exterior of the third pin end, wherein the fast setting epoxy compound fills the third annular groove and a third adjacent space between the third annular groove and the third tapered portion.

The second end of the third tubular member opposite the third pin end can have a connection to a receiving source, such as a storage tank.

The first tubular body, second tubular body, and third tubular body comprise a first depth insertion mark, a second depth insertion mark, and a third depth insertion mark respectively.

The first portion, can be from a first space between the first tapered portion and first depth insertion mark to the first bell end. The second portion can be a second space between the second tapered portion and the second depth insertion mark to the second bell end. A third portion comprises can be a third space between the third tapered portion and the third depth insertion mark to the connection to the receiving source.

The first space is between 0.01 inches to a 0.5 inches past the first depth insertion mark towards the first annular groove. The second space is between 0.01 inches to 0.5 inches past the second depth insertion mark towards the second annular groove. The third space is 0.01 inches to 0.5 inches past the third depth insertion mark towards the third annular groove. The portion of the pin end and the associated tubular that is going to be in contact with an interior of a bell end should not have a coating on it such as the smooth fusion powder epoxy coating or the three layer polyethylene coating.

In another embodiment of the subsea piping system can have the first tubular body having the first depth insertion mark disposed on the first tubular body allowing the first pin end to comprises a depth of insertion from 3 inches to 15 inches into the third bell end. The second tubular body further comprises the second depth insertion mark disposed on the first tubular body allowing the second pin end to comprises a depth of insertion from 3 inches to 15 inches into the first bell end. The third tubular body further comprises the third depth insertion mark disposed on the third tubular body allowing the third pin end to comprises a depth of insertion from 3 inches to 15 inches into the second bell end.

In another embodiment of the subsea piping system the first pin end, the second pin end, and the third pin end can also have an inverted bevel disposed on the tapered portion. The inverted bevel can be prefabricated by a steel manufacturer of the entire tubular member. The inverted bevel does not have to done in prefabrication and can be done by another party, after the pipe has been created by the pipe manufacturer. The inverted bevel has the benefit of improving the hydraulic efficiency through the joint.

The tubular members can be schedule 40 pipe. Other pipes, from as low as schedule 5 pipe to a maximum of schedule 80 pipe and even tip to 160 pipe can be used.

The interference fits formed when the pin ends interact with the bell end should not generate a gripping force between the bell ends and pin ends that would cause the pin ends to experience a stress greater than the elastic limit for each material used.

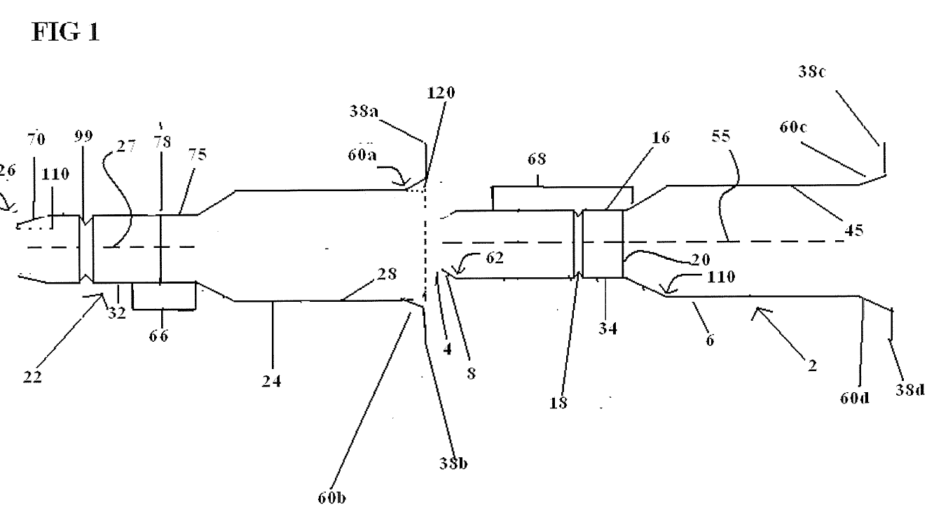

The subsea piping system can be better understood with reference to the figures. Referring now to FIG. 1, which depicts an exploded view of the first tubular member and second tubular member joined together.

FIG. 1 depicts a first tubular member 22. The first tubular member 22 selectively has a first tubular body 32 with a first bell end 24 on one side and a first pin end 26 on the opposite side. The first bell end 24 selectively includes a first interior 28, a fast setting epoxy compound, such as a mixture of 85% epoxy resin and 15% inert materials for friction reduction and pigmentation; and a smooth fusion epoxy coating, which can be replaced with a three layer polyethylene coating.

The first tubular member 22 selectively has a first exterior 75, which is an exterior for the first tubular body 32 including the first pin end 26, a first tapered end 70 formed between the first pin end 26 and the first tubular body 32, and a first annular groove 99 selectively disposed on the first tubular body 32 and a first depth insertion mark 78.

The first bell end 24 also has a first outward flare 60a disposed between the bell end 24 and a first face 38a, which is disposed above the first central axis 27, and a second outward flare 60b disposed between the first bell end 24 and a second face 38b, below the first central axis 27. The first outward flare 60a forms a first flare angle 120 relative to the first central axis 27. The second outward flare 60b forms a substantially similar angle relative to the first central axis 27.

A second tubular member 2 is also depicted in FIG. 1 selectively having a second tubular body 34 having a second pin end 4 on one side and a second bell end 6 on the opposite side. The second pin end 4 selectively includes a second tapered portion 8 disposed on the second tubular body 34. The fast setting epoxy compound, such as a mixture of 85% epoxy resin and 15% inert materials for function reduction and pigmentation is disposed on the second interior 45.

A smooth powder fusion epoxy is disposed on a second portion 68 of the second tubular member 2, the second bell end 6, the third outward flare 60c disposed between the second bell end 6 and a third face 38c, which is disposed above the central axis 55, and the fourth outward flare 60d disposed between the second bell end 6 and a fourth face 38d below the central axis 55.

The first portion 66 can be from up to 0.5 inches past the first depth insertion mark 78 towards the first annular groove 99 and extend to the first bell end 24 on the other side of the first depth insertion mark 78. The second portion 68 can be from up to 0.05 inches past the second depth insertion mark 20 towards the second annular groove 18 and from the second depth insertion marl 20 to the second bell end 6 on the other side of the second depth insertion mark.

The third outward flare forms a second flare angle 120b. The third outward flare 60c and the fourth outward flare 60d form a substantially similar angle relative to the second central axis 55. The second tubular member 2 also has a exterior 16 which includes the exterior of the pin end 4.

A second annular groove 18 is formed into the second tubular body 34. Further a second depth insertion mark 20 is depicted disposed on the second tubular body 34.

The second tapered portion 8 is selectively formed between the second pin end 4 and the second tubular body 34. The tapered portion 8 selectively has a second taper angle 62 ranging from 0.5 degrees to 10 degrees relative to the second central axis 55 of the second pin end 4.

The first tapered portion 70 is selectively formed between the first pin end 26 and the first tubular body 32. The tapered portion 70 selectively has a first taper angle 110 ranging from 0.5 degrees to 10 degrees relative to the first central axis 27 of the first pin end 26.

The fast setting epoxy compound is selectively disposed on the second exterior 16 of the second pin end 4 and the first interior 28 of the first bell end 24. The fast setting epoxy compound should fill the second annular groove 18 aid a second adjacent area located between the second tapered end 8 and the second annular groove 18.

The second annular groove 18 is selectively located on the second tubular body 34. The second annular groove 18 is selectively formed by a hydraulic groover or a ridge on a roller. The second annular groove 18 ensures a strong mechanical joint between the first tubular member 22 and the second tubular member 2.

The second annular groove 18 preferably has a depth ranging from 0.015 inches to 0.035 inches and a width ranging from 0.05 inches to 0.07 inches 0.015 inches to 0.035 inches and a width ranging from 0.05 inches to 0.07 inches. In an embodiment, the second annular groove 18 can be located between 0.05 inches and 1 inch from the end of the second pin end 4.

The fast setting epoxy compound acts as a lubricant and is a liquid epoxy and is applied to the first interior 28 of the first bell end 24 and second exterior 16 of the second pin end 4, such that it is “holiday free”, that is free of voids in the coating, that is, there are no bare spots on the tubular to joined. The joint between the first tubular member 22 and second tubular member 2 as disclosed allows for the fast setting epoxy to be applied to prevent damage during the stabbing process of the pin ends into the bell end, for example of second pin end 4 into first bell end 24. This is possible because of the interaction between the first bell end 24 and the second tapered portion 8.

Particularly, the first bell end 24 has the slight first outward flare 60a disposed between the first bell end 24 and a first face 38a above the first central axis 27, and a second outward flare 60b each disposed between the first bell end 24 and the second face 38b below the first central axis 27. Each outward flare forms a substantially similar angle relative to the first central axis 27, and the tapered portion 8 has a small inward taper angle 62 relative to the central axis 50. The first flare angle 120a formed by the outward flare 60a can be any angle less than the second taper angle 62. Good results have been experienced when a joint was made using a tapered end having an angle of 3 degrees and a pair of flares on the bell end of 4 degrees each for a joint on 6 inch diameter pipe wherein the stabbed in, overlapping portion of the joint an overall length between 7 and 10 inches, about 9.5 inches.

The fast setting epoxy compound allows the joined first member 22 and second member 2 to be submergible into deep water of a depth ranging from approximately 300 feet to 1000 feet in a relatively short period of time usually ranging from 1 minute to 2 minutes. The fast setting epoxy is also disposed on the first interior 28 of the first bell end 24.

The smooth powder fusion epoxy is disposed on a first portion 66, the first bell end 24, including the first outward flare 60a, the second outward flare 60b, the first face 38a, and the second face 38b.

In an alternative embodiment a three layer polyethylene coating can be substituted for the smooth fusion bond powder epoxy.

It is contemplated that the pill ends can have an insertion depth of between 5 inches to 14 inches into the respective bell ends depending on the size, the diameter of the pipe.

In this alternative embodiment of the subsea mechanical joint, the tapered ends can have an angle ranging from 0.5 degrees to 16 degrees.

In yet another alternative embodiment of the subsea mechanical joint, it is further contemplated that the bell ends can have an inner diameter of not less than the outer diameter of the pin end 4 less the product of 0.005 times the outer diameter of the inserted tubular member.

For example, but with out limitation, a “minimum interference fit” for steel has been determined to be approximately 0.005 inches of outside diameter per 30,000 pounds per square inch of minimum specified yield.

An embodiment contemplates using 0.003 inch, but 0.005 was used to compensate for miscellaneous irregularities which may be found in the tubular member.

For example, for a nominal 4.5 inch diameter pipe, the standards on such pipe allow a tolerance of plus or minus 0.75%. A 4.5 inch diameter pipe with A.P.I. standards may thus be encountered with an outside diameter as small as 4.46625 inches. Thus, to allow for the minimum desired interference of 0.0225 inches, the bell end must be expanded such that its dimension after “snap-back” is approximately 4.44 inches. Such sizing to obtain a “minimum interference fits has been found to satisfactorily accommodate pin ends of pipe with a maximum positive A.P.I. variation without significantly increasing the force required for joining, and while maintaining an adequate gripping force.

The relationship described above may be expressed as follows:

a. B.D.=Min O.D. pin-.005×, where

b. B.D.=bell inner diameter in inches;

c. Min O.D pin=smallest pin end outer diameter;

d. X=Nominal second tubular member outer diameter.

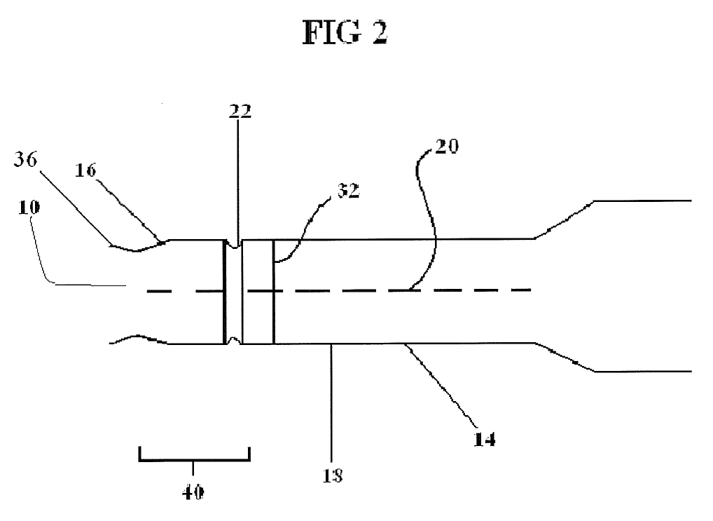

FIG. 2 depicts an alternative embodiment of the second pin end 4. The second pin end 4 selectively includes the second central axis 55. The second tapered portion 8 formed between the second tubular body 34 and the pin end 4. The fast setting epoxy compound, such as a mixture of 85% epoxy resin and 15% inert ingredients for friction reduction and pigmentation, is disposed on the exterior 16 of the pill end 4. The pin end 4 also has, the second annular groove 18, and the second depth insertion mark 20.

The second pin end 4 can have an inverted bevel 136 selectively disposed on the tapered portion 8. The inverted bevel is a tapered edge where the inside shoulder of the pin end has been removed. The inverted bevel is used to improve the geometry of the inside of the pipe joint. The inverted bevel has the benefit of improving the hydraulic efficiency through the connection

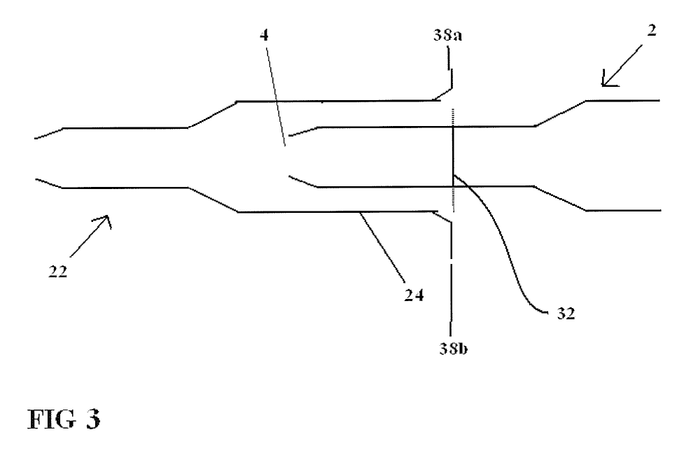

FIG. 3 depicts an assembled joint between the first tubular member 22 and the second tubular member 2. The second pin end 4 of the second tubular member 2 inserted into the first bell end 24 of the first tubular member 22. When the second pin end 4 is inserted into the first bell end 24 an interference fit is formed. Additionally, FIG. 3 depicts the second depth insertion mark 32 aligned perpendicularly to the first face 38a, and the second face 38b.

The joinder of the third pin end to the second bell end, and the joinder of the first pin end to the third bell end are substantially similar to the joinder of the first bell end to the second pin end.

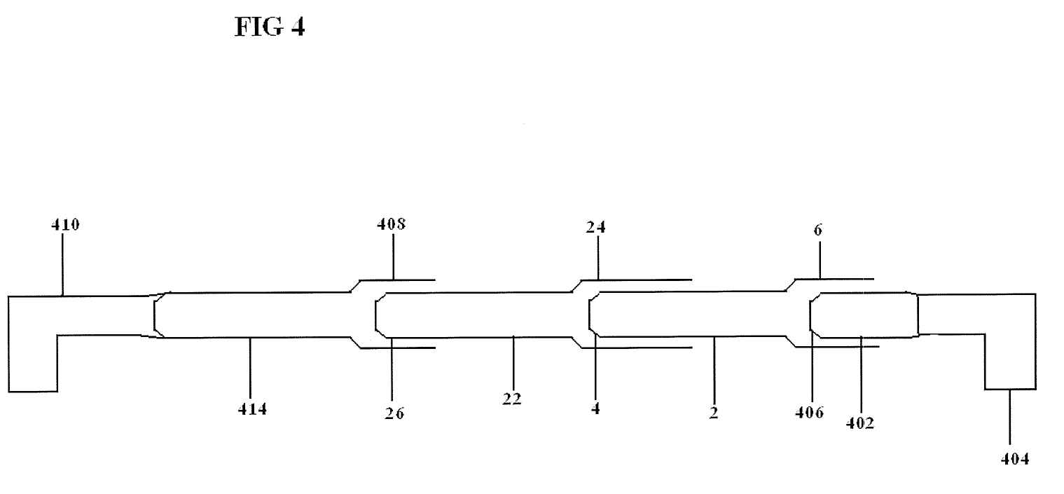

FIG. 4 depicts an assembled cut view of the piping system. The fourth tubular member 414 is shown operatively connected to a supply source 410 at one end. Tubular member 414 is shown operatively connected and at an opposite end in a third interference fit with the first tubular member 22. The third interference fit is formed when the first pin end 26 is disposed within the third bell end 408.

The first tubular member 22 is shown in a first interference fit with the second tubular member 2. The first interference fit between the first tubular member 22 and the second tubular member 2 is operatively formed when the bell end 24 operatively has the second pin end 4 disposed within it.

A second interference fit is operatively formed between the second tubular member 2 and the third tubular member 402. The second interference fit is formed when the third pin end 406 is operatively disposed within the second bell end 6. The end of the third tubular member 402 opposite the pin end 406 is operatively connected to a receiving source 404.

The piping system relates to a method for forming the joints that couple the tubular members together.

All embodiment of the method for forming a subsea mechanical joint can include forming a bell end in the end portion of a first tubular member. The bell end call receive a pin end of a second tubular member.

An embodiment of the method can include yielding the end portion of the first tubular member forming the bell end sized to receive the pill end of the second tubular member with an interference fit.

The yielding of the end portion of the first tubular member can be accomplished by using a hydraulic press, which exerts a pressure between the mandrel and end of the pipe. The hydraulic press exerts a force ranging from 10 to 50 tons, forcing the mandrel into the end portion of the first tubular member, causing it to yield. The mandrel is sized according to the tubular member that is used. The mandrel is made of hardened steel.

The present embodiment of the method can further include deforming the end portion of the second tubular member, which forms the pin end. The pin end can have a tapered portion.

The deforming operation can be accomplished by using a roll forming machine. The roll forming machine can have rollers. The rollers control the angle of the tapered portion of the pin end.

The present embodiment can also include forming all annular groove. The annular groove is formed by a ridge on the roller. The annular groove can be located on the exterior of a tubular body. The annular groove should be located as proximate to the tapered portion as practicable.

It is contemplated that the annular groove can be disposed within the bell end when the interference fit is made.

The first tubular member is coated with smooth powder fusion epoxy. The second tubular member is also coated with the smooth powder fusion epoxy, such as Scotchkote™ 6233, manufactured by 3M.

Simultaneously during the coating of the second tubular member the act of masking a portion of the second tubular member is performed which prevents the smooth fusion bond powder epoxy coating from disposing on the pin end and part of the second tubular body.

The portion that is masked is a space from up to 0.05 inches from a depth insertion mark towards the annular groove and extending to the end of the pin end.

The smooth fusion epoxy coating can be a thermosetting epoxy powder coating.

In an alternative embodiment a three layer polyethylene coating system can be used.

It is further contemplated that a first outward flare for receiving the pin end can be formed between the bell end and a first face, disposed above a central axis. A second outward flare for receiving the pin end can be formed between the bell end and a second face, disposed below the central axis. It is contemplated that in one embodiment these parts are coated with the smooth fusion powder epoxy and in a second embodiment with a three layer polyethylene.

The present embodiment of the method further includes applying a fast setting epoxy compound, such as a mixture of 85% epoxy resin and 15% inert ingredients for friction reduction and pigmentation, to the interior of the bell end and the exterior of the pin end.

The fast setting epoxy compound can be a compound having a fast curing time. The fast setting epoxy compound can be mixed using a machine that meters and mixes the fast setting epoxy compound and delivers it to a nozzle for the application of the fast setting epoxy compound to the tubular member by hand.

The fast setting epoxy compound should be applied so that when the interference fit is made, the fast setting epoxy compound fills the annular groove and an adjacent annular space between the tapered portion and the annular groove. The fast setting epoxy compound can be set in a span of time ranging from 1 minute to 10 minutes.

The present embodiment of the method also includes inserting the pin end into the bell end, creating the interference fit. The pin end is inserted into the bell end by using a hydraulic press.

When in the interference fit, the bell end exerts a compressive force on the pin end. The compressive force is usually less than the yield strength of the pin end. The pressure exerted on the pin end forms the subsea mechanical joint between the first tubular member and the second tubular member. The subsea mechanical joint is capable of withstanding a pressure equal to that of the first tubular member and second tubular member.

An alternative embodiment of the method can include coating the exterior of the first tubular member, including the bell end, and the entire second tubular member with a three layer polyethylene. Instead of applying the smooth fusion powder epoxy. Additionally the alternative embodiment can include removing a portion of the three layer polyethylene from the pin end.

In another alternative embodiment of the method further includes deforming the pin end and bell end relative to each other. This ensures that when the pin end and bell end are interfitted, they will have a minimum interference fit there between.

During the yielding of the end portion of the first tubular member, the bell end is strain hardened, which increases the yield strength of the end portion by up to about 10 percent.

It is also contemplated that the method can include applying a depth insertion mark to the second tubular body during coating. The insertion depth call be controlled by using the hydraulic press and stopping the hydraulic press when the depth insertion mark is perpendicular with the first face and second face of the bell end.

It is contemplated that the fast setting epoxy can set within a span of time ranging from 1 minute to 10 minutes.

It is also contemplated that the removed portion of the three layer polyethylene coating can range from 2 inches to 15 inches in length.

In an embodiment of the invention, the thickness of the smooth fusion bond powder epoxy coating can be thicker at the bell end and pin end than at the middle of the tubular members.

It is also contemplated that the deforming of the pin end can be accomplished by using a roll forming machine. The roll forming machine can have a set of rollers with pitch angles varying from 0.5 degrees to 10 degrees depending on whether the pipe is internally coated or not.

While these embodiments have been described with emphasis on the embodiments, it should be understood that within the scope of the appended claims, the embodiments might be practiced other than as specifically described herein.

What is claimed is:

1. A subsea piping system comprising:
a first tubular member comprising a first tubular body comprising:
a first pin end and a first bell end opposite the first pin end;
a second tubular member with a second tubular body disposed between a second pin end and a second bell end;
a third tubular member comprising a third tubular body comprising at least a third pin end disposed on the third tubular body; and
a fourth tubular member comprising a fourth tubular body comprising at least a third bell end disposed on the fourth tubular body;
wherein the first bell end comprises a first interior sized to form a first interference fit with the second pin end;
wherein the second tubular body comprises the second pin end, a second exterior, a second tapered portion formed between the second tubular body and the second pin end, and a second annular groove formed within the second tubular body;
wherein the first tubular member comprises a smooth fusion powder epoxy coating disposed on portion of the first tubular body, the first bell end, and the second tubular member comprises the smooth fusion powder epoxy coating disposed on a second portion of the second tubular body, and the second bell end;
a fast setting epoxy compound applied to the interior of the first bell end and the exterior of the second pin end, wherein the fast setting epoxy compound fills the second annular groove and a second adjacent space between the second annular groove and the second tapered portion;
wherein the third bell end comprises an interior sized to form a second interference fit with the first pin end;
wherein the first tubular body comprises the first pin end, a first exterior, a first tapered portion formed between the first tubular body and the first pill end, and a first annular groove formed within the first tubular body;
the fourth tubular member comprises the smooth fusion powder epoxy coating disposed on the fourth tubular body and the third bell end;
wherein the fast setting epoxy compound is applied to the third interior of the third bell end and the first exterior of the first pin end, wherein the fast setting epoxy compound fills the first annular groove and a first adjacent space between the first annular groove and the first tapered portion;
wherein a end of the fourth tubular member opposite the third bell end comprises a connection to a supply source;
wherein the second bell end of the tubular member comprises a second interior sized to form a third interference fit with the third pin end;
wherein the third tubular body comprises the third pin end, a third exterior, a third tapered portion formed between the third tubular body and the third pin end, and a third annular groove formed within the third tubular body;
wherein the third tubular member comprises the smooth fusion powder epoxy coating disposed on a third portion of the third tubular body;
wherein the fast setting epoxy compound is applied to the second interior of the second bell end and the third exterior of the third pin end, wherein the fast setting epoxy compound fills the third annular groove and a third adjacent space between the third annular groove and the third tapered portion;
wherein the second end of the third tubular member opposite the third pin end comprises a connection to a receiving source.

2. The subsea piping system of claim 1, wherein the first tubular body, second tubular body, and third tubular body comprise a first depth insertion mark, a second depth insertion mark, and a third depth insertion mark respectively.

3. The subsea piping system of claim 2, wherein the first portion comprises from a first space between the first tapered portion and first depth insertion mark to the first bell end, and the second portion comprises a second space between the second tapered portion and the second depth insertion mark to the second bell end, and the third portion comprises a third space between the third tapered portion and the third depth insertion mark to the connection to the receiving source respectively.

4. The subsea piping system of claim 3, wherein the first space is between 0.01 inches to a 0.5 inches past the first depth insertion mark towards the first annular groove, wherein the second space is between 0.01 inches to 0.5 inches past the second depth insertion mark towards the second annular groove, and wherein the third space is 0.01 inches to 0.5 inches past the third depth insertion mark towards the third annular groove.

5. The subsea piping system of claim 3, wherein the first tubular body further comprises the first depth insertion mark disposed on the first tubular body allowing the first pin end to comprises a depth of insertion from 3 inches to 15 inches into the third bell end.

6. The subsea piping system of claim 3, wherein the second tubular body further comprises the second depth insertion mark disposed on the first tubular body allowing the second pin end to comprises a depth of insertion from 3 inches to 15 inches into the first bell end.

7. The subsea piping system of claim 3, wherein the third tubular body further comprises the third depth insertion mark disposed on the third tubular body allowing the third pin end to comprises a depth of insertion from 3 inches to 15 inches into the second bell end.

8. The subsea piping system of claim 1, wherein the first pin end further comprises an inverted bevel disposed on the first tapered portion.

9. The subsea piping system of claim 1, wherein the second pin end further comprises an inverted bevel disposed on the second tapered portion.

10. The subsea piping system of claim 1, wherein the third pin end further comprises an inverted bevel disposed on the third tapered portion.

11. The subsea piping system of claim 1, wherein the fast setting epoxy compound comprises substantially equal amounts of an epoxy base and an epoxy accelerator, wherein the epoxy base comprises:
an epoxy resin, wherein the epoxy resin comprises approximately 60 weight percent of the epoxy base based on the total weight of the epoxy base;
a dispersion agent, wherein the dispersion agent comprises approximately 2 weight percent of the epoxy base based on the total weight of the epoxy base;
a hydrocarbon resin, wherein the hydrocarbon resin comprises approximately 3 weight percent of the epoxy base based on the total weight of the epoxy base;
a titanium dioxide, wherein the titanium dioxide comprises approximately 4 weight percent of the epoxy base based on the total weight of the epoxy base;
a micro-crystalline filler, wherein the micro-crystalline filler comprises approximately 15 weight percent of the epoxy base based on the total weight of the epoxy base;
a talc, wherein the talc comprises approximately 15 weight percent of the epoxy base based on the total weight of the epoxy base; and
a flatting agent, wherein the flatting agent comprises approximately 1 weight percent of the epoxy base based on the total weight of the epoxy base; and
wherein the epoxy accelerator comprises:
an epoxy reactive diluent, wherein the epoxy reactive diluent comprises approximately 4 weight percent of the epoxy accelerator based on the total weight of the epoxy accelerator;
a hybrid reactive polyamide, wherein the hybrid reactive polyamide comprises approximately 10 weight percent of the epoxy accelerator based on the total weight of the epoxy accelerator;
an epoxy curing agent, wherein the epoxy curing agent comprises approximately 35 weight percent of the epoxy accelerator based on the total weight of the epoxy accelerator;
a dimethylamino-accelerator, wherein the dimethylamino-accelerator comprises approximately 10 weight percent of the epoxy accelerator based on the total weight of the epoxy accelerator;
a phthalo blue dispersion agent, wherein the phthalo blue dispersion agent comprises approximately 1 weight percent of the epoxy accelerator based on the total weight of the epoxy accelerator;
a talc, wherein the talc comprises approximately 20 weight percent of the epoxy accelerator based on the total weight of the epoxy accelerator; and
a micro-crystalline filler, wherein the micro-crystalline filler comprises approximately 20 weight percent of the epoxy accelerator based on the total weight of the epoxy accelerator.

12. A sub-sea piping system comprising:
a first tubular member comprising a first tubular body comprising a first pin end and a first bell end comprising a first outward flare disposed between the first bell end and a first face, wherein the first outward flare is disposed above a first central axis of the first tubular body, and a second outward flare disposed between the first bell end and a second face, wherein the second outward flare is disposed below the first central axis;
a second tubular member with a second tubular body comprising a second pin end and a second bell end comprising a third outward flare disposed between the second bell end and a third face, wherein the third outward flare is disposed above a second central axis, and a fourth outward flare disposed between the second bell end and a fourth face, and wherein the fourth outward flare is disposed below the second central axis;
a third tubular member comprising a third tubular body comprising at least one third pin end, and a fourth tubular member comprising a fourth tubular body comprising at least one third bell end comprising a fifth outward flare disposed between the third bell end and a fifth face, wherein the fifth outward flare is disposed above a fourth central axis, and a sixth outward flare disposed between the third bell end and a sixth face, and wherein the sixth outward flare is disposed below the third central axis;
wherein the first bell end comprises a first interior sized to form a first interference fit with the second pin end;
wherein the second tubular body comprises a second pin end, a second exterior, a second tapered portion formed between the second pin end and the second tubular body, and a second annular groove formed within the second tubular body;
wherein the first tubular member comprises a three layer polyethylene coating disposed on a first portion of the first tubular body, the first bell end, and the second tubular member comprises the three layer polyethylene coating disposed oil a portion of the second tubular body, and the second bell end;
a fast setting epoxy compound applied to the interior of the first bell end and the exterior of the second pin end, wherein the fast setting epoxy compound fills the second annular groove and a second adjacent space between the second annular groove and the second tapered portion;
wherein the third bell end comprises an interior sized to form a second interference fit with the first pin end;
wherein the first tubular body comprises the first pin end comprises a first exterior, a first tapered portion formed between the first tubular body and the first pin end, and a first annular groove formed within the first tubular body;
wherein the fourth tubular member comprises the three layer polyethylene coating disposed on a portion of the fourth tubular body and the third bell end;
wherein the fast setting epoxy compound is applied to the third interior of the third bell end and the first exterior of the first pin end, wherein the fast setting epoxy compound fills the first annular groove and a first adjacent space between the first annular groove and the first tapered portion;
wherein a end of the fourth tubular member opposite the third bell end comprises a connection to a supply source;
wherein the second bell end comprises and a second interior sized to form a third interference fit with the third pin end;
wherein the third pin end comprises a third exterior, a third tapered portion formed between the third tubular body, and a third annular groove formed within the third tubular body;
wherein the third tubular member comprises the three layer polyethylene coating disposed on a third portion of the third tubular body;
the fast setting epoxy compound applied to the second interior of the second bell end and the third exterior of the third pin end, wherein the third fast setting epoxy compound fills the third annular groove and a third adjacent space between the third annular groove and the third tapered portion;
wherein the end of the third tubular member opposite the third pin end comprises a connection to a receiving source.

13. The subsea piping system of claim 12, wherein the first tubular body, second tubular body, and third tubular body comprise a first depth insertion mark, a second depth insertion mark, and a third depth insertion mark respectively.

14. The subsea piping system of claim 13, wherein the first portion comprises from a first space between the first tapered portion and first depth insertion mark to the first bell end, and the second portion comprises a second space between the second tapered portion and the second depth insertion mark to the second bell end, and the third portion comprises a third space between the third tapered portion and the third depth insertion mark to the connection to the receiving source respectively.

15. The subsea piping system of claim 14, wherein the first space comprises between 0.01 inches to a 0.5 inches past the first depth insertion mark towards the first annular groove, wherein the second space comprises between 0.01 inches to 0.5 inches past the second depth insertion mark towards the second annular groove, and wherein the third space comprises 0.01 inches to 0.5 inches past the third depth insertion mark towards the third annular groove.

16. The subsea piping system of claim 14, wherein the first tubular body further comprises the first depth insertion mark disposed on the first tubular body allowing the first pin end to comprises a depth of insertion from 3 inches to 15 inches into the third bell end.

17. The subsea piping system of claim 14, wherein the second tubular body further comprises the second depth insertion mark disposed on the first tubular body allowing the second pin end to comprises a depth of insertion from 3 inches to 15 inches into the first bell end.

18. The subsea piping system of claim 14, wherein the third tubular body further comprises the third depth insertion mark disposed on the third tubular body allowing the third pin end to comprises a depth of insertion from 3 inches to 15 inches into the second bell end.

19. The subsea piping system of claim 12, wherein the first pin end further comprises an inverted bevel disposed on the first tapered portion.

20. The subsea piping system of claim 12, wherein the second pin end further comprises all inverted bevel disposed on the second tapered portion.

21. The subsea piping system of claim 12, wherein the third pin end further comprises an inverted bevel disposed on the third tapered portion.

22. The subsea piping system of claim 12, wherein the first pin end, the second pin end, and the third pin end comprise a first depth insertion mark, second depth insertion mark, and third depth insertion mark respectively, disposed on the first tubular body, the second tubular body, and the third tubular body respectively.
